(19) United States
(12) Patent Application Publication
(10) Pub. No.: US 2006/0261685 A1
(43) Pub. Date: Nov. 23, 2006

(54) Safety device in electric power tools and/or electrical appliances

(76) Inventors: Harald Schindler, Stuttgart (DE); Michael Mayer, Wiernsheim/Pinache (DE)

Correspondence Address: STRIKER, STRIKER & STENBY, 103 EAST NECK ROAD, HUNTINGTON, NY, 11743, US

(21) Appl. No.: 11/434,083

(22) Filed: May 15, 2006

(30) Foreign Application Priority Data
May 20, 2005 (DE) 10 2005 023 357.0

(51) Int. Cl. H02K 11/00

(52) U.S. Cl. 310/50; 310/68 B

(57) ABSTRACT

In a sensor device in electric power tools and/or electrical appliances which have a mains-operated electric drive motor in a housing, a sensor device is provided, which monitors a properly closed state of the housing and upon a deviation from the properly closed state switches the drive motor to be voltage-free.

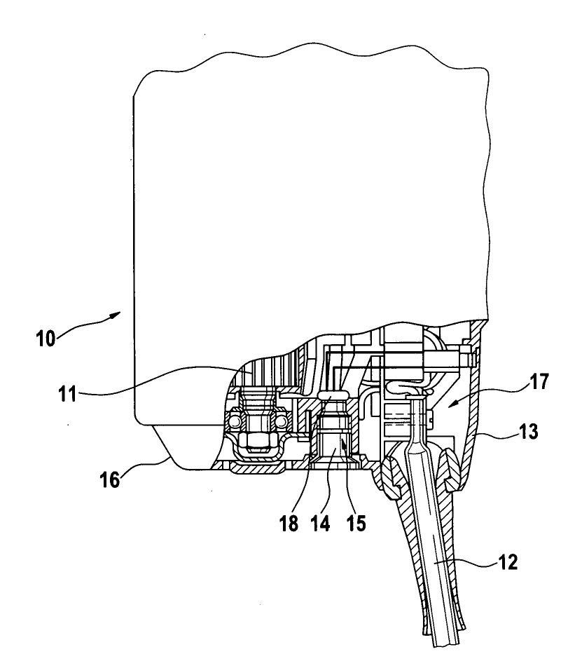

### CROSS-REFERENCE TO A RELATED APPLICATION

The invention described and claimed hereinbelow is also described in German Patent Application DE 10 2005 0233 57.0, filed May 20, 2005. This German Patent Application, whose subject matter is incorporated here by reference, provides the basis for a claim of priority of invention under 35 U.S.C. 119(a)-(d).

### BACKGROUND OF THE INVENTION

The invention relates to a housing assembly of electric power tools and electrical appliances.

If housings of electrical appliances or electric power tools are opened, the power plug of the appliance must first be pulled out from the voltage source. If this is not done, there is a risk to the user from electrical shock or moving gear parts.

### SUMMARY OF THE INVENTION

Accordingly, it is an object of the present invention to provide a safety device in electric power tools and/or electric appliances which is a further improvement of the existing safety devices.

In keeping with these objects and with others which will become apparent hereinafter, one feature of the present invention resides, briefly stated, in a safety device in electric power tools and/or electrical appliances, which have a mains-operated electric drive motor in a housing, wherein a sensor device is proposed, which monitors a properly closed state of the housing and upon a deviation from the properly closed state switches the drive motor to be voltage-free.

This enhances a user's safety. If the user intentionally or unintentionally opens the electric power tool or the electrical appliance, or if the housing parts or coverings are not closed as prescribed, and major damage occurs, the user is protected against possible dangers. In servicing, for instance, if carbons or cords are being changed, the risk of electric shock can be largely precluded.

A control function is also possible by way of perfect assembly and perfect condition of the manufactured appliances when shipped.

It is advantageous if the sensor unit is connected to fastening screws in the housing, so that loosening of the screws causes the electric motor to be made voltage-free.

Preferably, the sensor device is located near a covering which covers a drive motor region that is subjected to electrical voltage, so that a region of increased potential risk can be monitored.

In this connection, it is also favorable if the sensor device is located near a covering which covers a region having movable gear parts.

Preferably, the sensor device is connected to a stop switch. If the sensor unit detects opening of the appliance, at least one region of a brush holder of the electric motor is preferably switched to be voltage-free.

In a favorable feature, the sensor device is embodied for detecting major damage to the covering.

It is also favorable if the sensor device is connected to an electronic unit for the motor, which is intended for controlling or regulating the electric motor.

Further embodiments, aspects and advantages of the invention will also become apparent, regardless of their being summarized in claims, without restriction to generality, from the exemplary embodiment of the invention described below and shown in a drawing.

### BRIEF DESCRIPTION OF THE DRAWINGS

The sole drawing FIGURE, in a longitudinal section, shows a detail of a preferred electric power tool with a sensor unit in accordance with the present invention.

### DESCRIPTION OF THE PREFERRED EMBODIMENTS

A preferred safety device in an electric power tool 10 in accordance with the present invention is shown in the drawing.

The electric power tool 10 has a mains-operated electric drive motor 11 in a housing 16. A power cord 12 feeds into the housing 16 and is covered there with a covering region 13 of the housing 16.

The covering region 13 above all covers an area surrounding the electric motor 11, which includes the region 17 of the brush holder.

A sensor device 15 is provided, which monitors a properly closed state of the housing 16 and upon a deviation from the properly closed state switches the drive motor 11 to be voltage-free. A sensor 18 of the sensor unit 15 is in contact with a fastening screw 14 of the housing 16.

The fastening screw 14 secures the electrically critical covering region 13 in the vicinity of the brush holder. If the fastening screw 14 is loosened, the electric motor 11 or brush holder is switched to be without voltage.

To that end, the sensor unit 15 is expediently connected to a conventional electronic unit for the motor, not shown, which then switches off the electric motor 11 in response to the sensor signal.

It will be understood that each of the elements described above, or two or more together, may also find a useful application in other types of constructions differing from the types described above.

While the invention has been illustrated and described as embodied in a safety device in electric power tools and/or electrical appliances, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A safety device in an apparatus selected from the group consisting of an electric power tool, an electrical appliance, and both, having a main-operated electric drive motor in a housing, the safety device, comprising a sensor device configured for monitoring a properly closed state of a housing, and a point of deviation from the properly closed state switches the drive motor to be voltage-free.

2. A safety device as defined in claim 1, wherein said sensor device is arranged so that it is located near a covering which covers a region of the drive motor that is subjected to electrical voltage.

3. A safety device as defined in claim 1, wherein said sensor device is arranged so that it is located near a covering which covers a region having movable gear parts.

4. A safety device as defined in claim 2; and further comprising a stop switch, said sensor device being connected to said stop switch.

5. A safety device as defined in claim 1, wherein said sensor device is configured for detecting major damage to the covering.

6. A safety device as defined in claim 1; and further comprising means for connecting said sensor device to an electronic unit for the motor.

7. An electrical apparatus selected from the group consisting of an electric power tool, an electrical appliance, and both, comprising a main-operated electric drive motor; a housing accommodating said electric drive motor; and a sensor device which is configured so as to monitor a properly closed state of said housing and upon a deviation from the properly closed state switches said drive motor to be voltage-free.
